(19) United States
(12) Patent Application Publication
(10) Pub. No.: US 2015/0312645 A1
(43) Pub. Date: Oct. 29, 2015

(54) APPARATUS AND METHOD FOR TRANSMITTING AND RECEIVING DISASTER INFORMATION

(71) Applicant: Electronics and Telecommunications Research Institute, Daejeon (KR)

(72) Inventors: You Seok LEE, Daejeon (KR); Kwanwoong RYU, Daejeon (KR); Heung Mook KIM, Daejeon (KR); Jin Hyuk SONG, Daejeon (KR); Jae Hyun SEO, Daejeon (KR); Ho Min EUM, Daejeon (KR)

(21) Appl. No.: 14/677,930

(22) Filed: Apr. 2, 2015

(30) Foreign Application Priority Data
Apr. 25, 2014 (KR) 10-2014-0050044

(51) Int. Cl. H04N 21/81; H04N 21/43; H04N 21/438; H04N 21/2383; H04N 21/242

(52) U.S. Cl. CPC H04N 21/814; H04N 21/2383; H04N 21/242; H04N 21/4382; H04N 21/4302

(57) ABSTRACT

When a disaster occurs, a disaster information transmitting apparatus generates disaster information, spreads the disaster information with a spreading code, modulates the spread disaster information, and transmits the modulated disaster information using a guard band of a broadcasting frequency band.

### CROSS-REFERENCE TO RELATED APPLICATION

This application claims priority to and the benefit of Korean Patent Application No. 10-2014-0050044 filed in the Korean Intellectual Property Office on Apr. 25,2014, the entire contents of which are incorporated herein by reference.

### BACKGROUND OF THE INVENTION

(a) Field of the Invention

The present invention relates to a method and apparatus for transmitting and receiving disaster information. More particularly, the present invention relates to a method and apparatus for transmitting and receiving disaster information while minimizing interference with a broadcasting signal.

(b) Description of the Related Art

As digital broadcasting spreads, additional data such as news, stock reports, weather information, traffic information, and disaster information in addition to an image and a sound for broadcasting may be transmitted. Therefore, a user may receive additional data together with broadcasting.

Furthermore, in a broadcasting communication convergence environment in which a broadcasting network and a communication network are interlocked to be of service, a user terminal has both a broadcasting receiving module and a communication module. Disaster information should be urgently transmitted for damage prevention and preparation. When disaster information is transmitted through a broadcasting network, if broadcasting is not viewed, disaster information cannot be provided. Alternatively, when disaster information is transmitted through a wireless communication network, a frequency band for transmitting and receiving disaster information should be additionally allocated, and in an environment in which a signal-to-noise ratio (SNR) of a received signal is low, it is difficult to accurately extract disaster information. Therefore, a new method that can transmit disaster information when broadcasting is not viewed or even in a low SNR environment without additional frequency band allocation.

### SUMMARY OF THE INVENTION

The present invention has been made in an effort to provide a method and apparatus for transmitting and receiving disaster information having advantages of being capable of providing disaster information even in a low SNR environment without frequency band allocation of a wireless communication network.

An exemplary embodiment of the present invention provides a disaster information transmitting apparatus. The disaster information transmitting apparatus includes a disaster information generator, a spreading unit, a modulation unit, and a transmitting unit. The disaster information generator generates disaster information. The spreading unit spreads the disaster information with a spreading code. The modulation unit modulates spread disaster information. The transmitting unit transmits modulated disaster information using a guard band of existing between two adjacent broadcasting frequency channels.

The broadcasting frequency band may be divided into a frequency block on a broadcasting channel basis, the guard band may be a frequency band that is not used between adjacent frequency blocks, and a broadcasting signal may be transmitted using a frequency block of a corresponding broadcasting channel.

Another embodiment of the present invention provides a disaster information receiving apparatus. The disaster information receiving apparatus includes a receiving unit, a demodulation unit, a despreading unit, and a disaster information analysis unit. The receiving unit receives a signal including transmitted disaster information using a guard band existing between two adjacent broadcasting frequency channels from a disaster information transmitting apparatus. The demodulation unit demodulates a received signal. The despreading unit despreads a demodulated signal using a despreading code. The disaster information analysis unit extracts the disaster information from a despread signal.

The disaster information receiving apparatus may further include a controller that controls a television using the extracted disaster information.

The controller may include a set-top box.

The despreading unit may include: a correlation unit that calculates a correlation value between a demodulated signal and the despreading code; a frame synchronization detection unit that detects a data synchronization time point using a correlation value that is calculated by the correlation unit; a despread error compensation unit that compensates and outputs a correlation value that is calculated by the correlation unit; and a data determining unit that extracts a correlation value that is compensated by the despread error compensation unit to determine data at every cycle corresponding to a length of the despreading code based on the data synchronization time point.

A compensation segment may be set to the sum of lengths that are set at a previous time point and a following time point of a present time point of an input correlation value.

The despreading unit may further include a despread peak value extractor that extracts a correlation value of a corresponding location and that transfers the correlation value to the data determining unit at every cycle corresponding to a length of the despreading code based on the data synchronization time point among correlation values that are output from the despread error compensation unit.

The despread error compensation unit may output the sum of the entire correlation values of a compensation segment that is set based on a present correlation value as a compensation value of the present correlation value.

The broadcasting frequency band may be divided into a frequency block on a broadcasting channel basis, and the guard band may include a frequency band that is not used between adjacent frequency blocks.

Yet another embodiment of the present invention provides a method of transmitting disaster information in a disaster information transmitting apparatus. The method includes: generating disaster information; spreading the disaster information with a spreading code; modulating the spread disaster information; and transmitting the modulated disaster information using a guard band of a broadcasting frequency band.

The broadcasting frequency band may be divided into a frequency block assigned to each broadcasting channel, the guard band may be a frequency band that is not used between adjacent frequency blocks, and the transmitting of the modulated disaster information may include controlling signal intensity of the disaster information.

Yet another embodiment of the present invention provides a method of receiving disaster information in a disaster information receiving apparatus. The method includes: receiving a signal including disaster information that is transmitted using a guard band of a broadcasting frequency band from a disaster information transmitting apparatus; demodulating the received signal; despreading the demodulated signal using a code which used for spreading; and extracting the disaster information from the despread signal.

The method may further include controlling a television using the extracted disaster information.

The controlling of the television may include turning on a power of the television.

The controlling of a television may include converting a broadcasting channel of the television to a disaster broadcasting channel.

The despreading of the demodulated signal may include: calculating a correlation value between a demodulated signal and the code; detecting a data synchronization time point using the calculated correlation value; compensating and outputting the calculated correlation value; and extracting a correlation value that is compensated at a corresponding location and determining data at every cycle corresponding to a length of the code based on the data synchronization time point.

The outputting of the calculated correlation value may include calculating the sum of all correlation values of a compensation segment that is set based on a present correlation value as a compensation value of the present correlation value.

### BRIEF DESCRIPTION OF THE DRAWINGS

FIG. 1 is a diagram illustrating a disaster information broadcasting system according to an exemplary embodiment of the present invention.

FIG. 2 is a diagram illustrating a disaster information transmitting apparatus of FIG. 1.

FIG. 3 is a flowchart illustrating a method of transmitting disaster information according to an exemplary embodiment of the present invention. FIG. 4 is a diagram illustrating an example of a disaster information receiving apparatus of FIG. 1.

FIG. 5 is a flowchart illustrating a method of receiving disaster information according to an exemplary embodiment of the present invention.

FIG. 6 is a diagram illustrating a despreading unit of FIG. 4.

FIG. 7 is a flowchart illustrating a despread method of the despreading unit of FIG. 6.

FIG. 8 is a diagram illustrating a method of compensating a timing synchronization error of a despread error compensation unit of FIG. 6.

FIG. 9 is a schematic diagram illustrating a disaster information transmitting apparatus or a disaster information receiving apparatus according to another embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for transmitting and receiving disaster information according to an exemplary embodiment of the present invention will be described in detail with reference to the drawings.

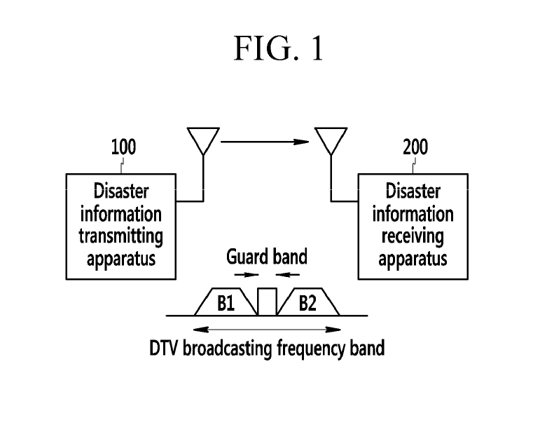

FIG. 1 is a diagram illustrating a disaster information broadcasting system according to an exemplary embodiment of the present invention.

Referring to FIG. 1, the disaster information broadcasting system includes a disaster information transmitting apparatus 100 and a disaster information receiving apparatus 200.

The disaster information transmitting apparatus 100 generates disaster information when a disaster occurs, modulates disaster information, and transmits the modulated disaster information as a disaster broadcasting signal using a guard band of a terrestrial Digital Television (DTV) broadcasting frequency band.

The DTV frequency band may be divided into frequency blocks B1 and B2 on a broadcasting channel basis, and a guard band is set between adjacent frequency blocks. For convenience, FIG. 1 illustrates only two frequency blocks B1 and B2. The guard band is a frequency band that is not used between designated broadcasting channels, and reduces interference between adjacent broadcasting channels.

In order to transmit disaster information through a guard band, the disaster information transmitting apparatus 100 may transmit disaster information with signal intensity of a level to not give interference to a broadcasting signal of a broadcasting channel.

The disaster information receiving apparatus 200 receives disaster information that is transmitted with a guard band.

In this way, because the disaster information transmitting apparatus 100 transmits disaster information using a guard band that is not used between broadcasting channels, in order to transmit disaster information, the disaster information transmitting apparatus 100 does not require allocation of an additional frequency band of a wireless communication network. Further, the disaster information transmitting apparatus 100 can minimize an influence on receiving performance of an existing terrestrial DTV signal through signal intensity control of disaster information.

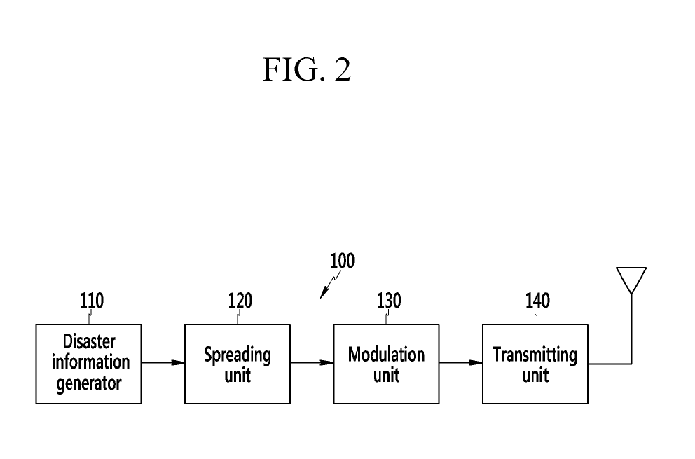

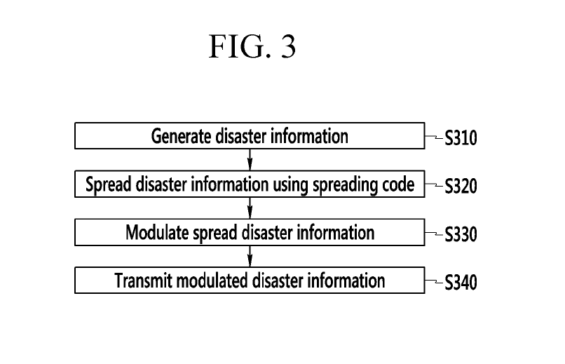

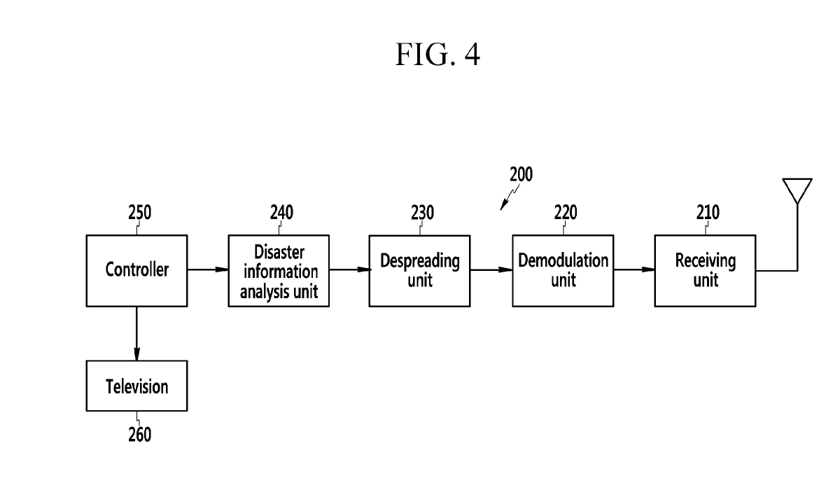

FIG. 2 is a diagram illustrating a disaster information transmitting apparatus of FIG. 1, and FIG. 3 is a flowchart illustrating a method of transmitting disaster information according to an exemplary embodiment of the present invention.

Referring to FIG. 2, the disaster information transmitting apparatus 100 includes a disaster information generator 110, a spreading unit 120, a modulation unit 130, and a transmitting unit 140.

Referring to FIG. 3, when a disaster occurs, the disaster information generator 110 generates disaster information (S310).

The spreading unit 120 spreads disaster information using a spreading code (S320). As the spreading code, for example, pseudo-random noise progression may be used.

The modulation unit 130 modulates the spread disaster information (S330).

The transmitting unit 140 transmits the modulated disaster information as a disaster broadcasting signal using a guard band of a terrestrial DTV broadcasting frequency band (S340).

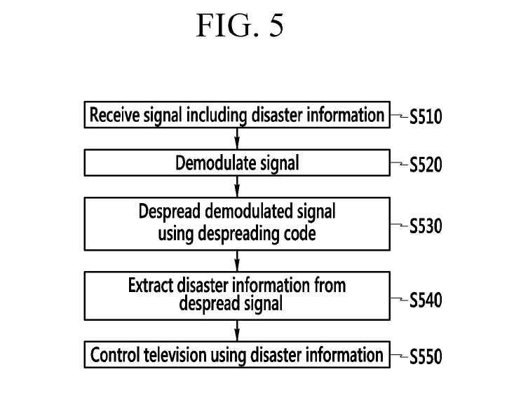

FIG. 4 is a diagram illustrating an example of a disaster information receiving apparatus of FIG. 1, and FIG. 5 is a flowchart illustrating a method of receiving disaster information according to an exemplary embodiment of the present invention.

Referring to FIG. 4, the disaster information receiving apparatus 200 includes a receiving unit 210, a demodulation unit 220, a despreading unit 230, a disaster information analysis unit 240, a controller 250, and a television 260.

The receiving unit 210 receives a signal including disaster information that is transmitted using a guard band from the disaster information transmitting apparatus 100 (S510).

The demodulation unit 220 demodulates the received signal (S520).

The despreading unit 230 generates a despreading code and despreads the demodulated signal using the despreading code (S530). The despreading code is the same code as a spreading code that is used upon spreading in the disaster information transmitting apparatus 100.

The disaster information analysis unit 240 extracts disaster information from a despread signal (S540).

The controller 250 controls television using disaster information that is extracted from the disaster information analysis unit 240 (S550). The controller 250 may transfer a control signal for controlling a television to the television 260. For example, when power of the television 260 is turned off, the controller 250 may turn on power of the television 260, convert a channel of the television 260 to a disaster broadcasting channel, and control audio volume of the television 260. When the television 260 is turned on, the controller 250 may control a disaster broadcasting channel and audio volume of the television 260.

The controller 250 may be a set-top box. In this case, the controller 250 receives a DTV broadcasting signal and transfers the DTV broadcasting signal to the television 260.

The television 260 provides a DTV broadcasting service according to a DTV broadcasting signal. The television 260 may directly receive a DTV broadcasting signal. The television 260 may control power according to the control of the controller 250 and control a disaster broadcasting channel and audio volume.

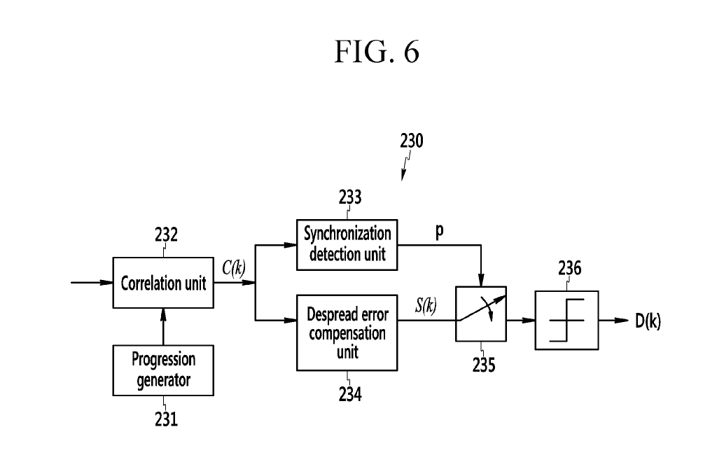

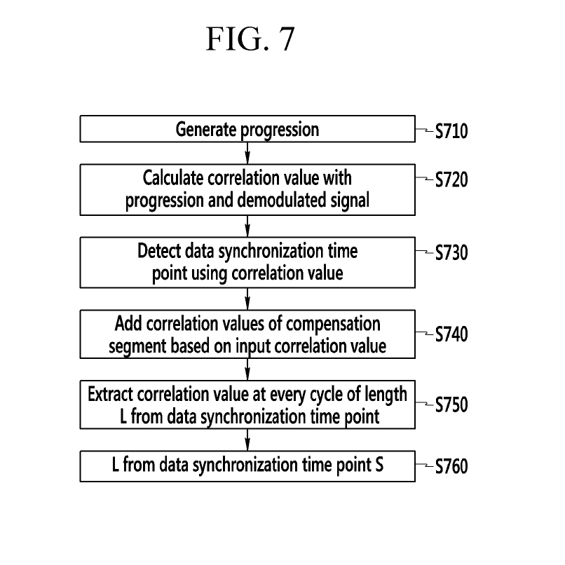

FIG. 6 is a diagram illustrating a despreading unit of FIG. 4, and FIG. 7 is a flowchart illustrating a despread method of the despreading unit of FIG. 6.

Referring to FIG. 6, the despreading unit 230 includes a progression generator 231, a correlation unit 232, a synchronization detection unit 233, a despread error compensation unit 234, a despread peak value extractor 235, and a data determining unit 236.

Referring to FIG. 7, the progression generator 231 generates the same progression as progression that is used for spreading (S710). The progression that is used for spreading is a spreading code, and a progression that is generated by the progression generator 231 is a despreading code.

The correlation unit 232 calculates a correlation value with the progression that is generated in the progression generator 231 and a demodulated signal (S720).

The synchronization detection unit 233 detects a data synchronization time point p corresponding to a start location of data using a correlation value that is calculated by the correlation unit 232 (S730). The synchronization detection unit 233 transfers the data synchronization time point p to the despread peak value extractor 235. The synchronization detection unit 233 may determine a location of a correlation value of a predetermined threshold value or more among correlation values that are calculated by the correlation unit 232 as a data synchronization time point p, and a threshold value that is used at this time may be changed.

In order to compensate a peak detection error of a correlation value of the synchronization detection unit 233 that may be present in a low SNR area, when a correlation value [C(k)] is input by the correlation unit 232, the despread error compensation unit 234 compensates and outputs the correlation value [C(k)]. The despread error compensation unit 234 outputs a value [S(k)] in which all correlation values of a compensation segment are added based on the input correlation value [C(k)] like Equation 1 as a compensation value of the correlation value [C(k)] (S740). The compensation segment may be set to the sum of lengths that are set at a previous time point and a following time point based on a present time point of the input correlation value.

$$S ( k ) = {\sum }_{i = - h}^{i = h} C ( k - i ) \qquad ( Equation 1 )$$

In Equation 1, S(k) is an output value of the despread error compensation unit 234 and is a compensation value of a correlation value [C(k)], and C(k) is a correlation value that is output from the correlation unit 232. b is a constant determining a compensation segment and may be set to a random value. In Equation 1, a compensation segment may be determined from −b to +b based on a present time point k of an input correlation value.

The despread peak value extractor 235 extracts a correlation value at every cycle NL of a length L from a data synchronization time point p among correlation values that are output from the despread error compensation unit 234, and transfers the extracted correlation value to the data determining unit 236 (S750). L is a length of a progression, and in FIG. 6, N is an integer of 0 or more.

The data determining unit 236 determines data [D(k)] using a correlation value that is extracted by the despread peak value extractor 235 and a threshold value (S760).

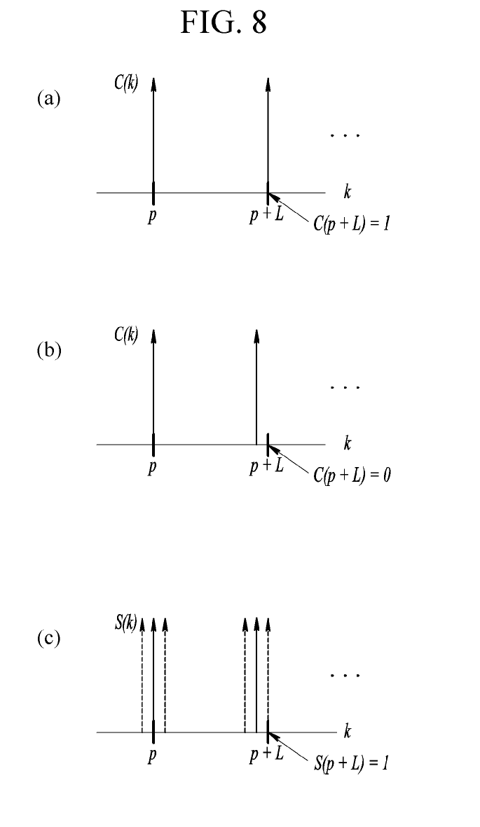

FIG. 8 is a diagram illustrating a method of compensating a despread peak detection error of a despread error compensation unit of FIG. 6.

Referring to FIG. 8, when an error does not occur in chip synchronization of a spreading code, i.e., timing synchronization, as shown in FIG. 8 (a), a peak value of a correlation value may be detected at every cycle NL of a length L from a data synchronization time point p. That is, when a data synchronization time point is p, a peak value of a correlation value [c(p+L)] at a (p+L) location is represented.

However, in a low SNR area, when an error occurs in timing synchronization by noise, a location in which an actual peak value is represented is changed by a timing synchronization error, as shown in FIG. 8 (b), and thus an error occurs. When a peak detection error of such a correlation value occurs, as shown in FIG. 8 (b), a peak value of a correlation value may not be detected at every cycle NL of a length L from a data synchronization time point p. That is, a correlation value [c(p+L)] at a (p+L) location may be 0.

As shown in FIG. 8 (b), in order to compensate a peak detection error of a correlation value, the despread error compensation unit 234 compensates and outputs a correlation value with an entire added value of a correlation value of a compensation segment for an entire input correlation value. Hereinafter, as shown in FIG. 8 (c), at every cycle NL of a length L from the data synchronization time point p, a correlation value [C(p+NL)] is compensated with an entire added value [S(p+NL)] of correlation values of a compensation segment.

For example, in Equation 1, when b is set to 1, the despread error compensation unit 234 outputs an added value [S(p+NL)] of a correlation value [p+L−1], a correlation value [C(p+L)], and a correlation value [C(p+L+1)] to a compensation value of the correlation value [C(p+L)] instead of outputting an input correlation value [C(p+L)], and the despread peak value extractor 235 extracts a compensation value [S(p+L)] at a (p+NL) location. Hereinafter, as shown in FIG. 8 (b), at a location of a length L from a data synchronization time point p due to a correlation value peak detection error, even when a correlation value is detected to 0, at a location of the length L from the data synchronization time point p by the despread error compensation unit 234, 1 may be extracted by the despread error compensation unit 234.

In this way, the despread error compensation unit 234 performs a function of extending a peak detection range of a correlation value. Therefore, even if a peak location of a correlation value is not represented at a (p+L) location, when a peak of the correlation value exists within a ±b range based on p, a peak value of a correlation value may be extracted and thus data may be accurately restored. Further, when a start location of data is determined, even if a sampling time for extracting data is not changed, data may be more accurately restored and thus it is advantageous from an implementation viewpoint. Therefore, even in a low SNR area, receiving performance can be improved.

At least a partial function of an apparatus and method for transmitting and receiving disaster information according to the foregoing exemplary embodiment of the present invention may be implemented with hardware or may be implemented with software that is combined with hardware.

For example, an embodiment of the present invention may be implemented in a computer system, e.g., as a computer readable medium.

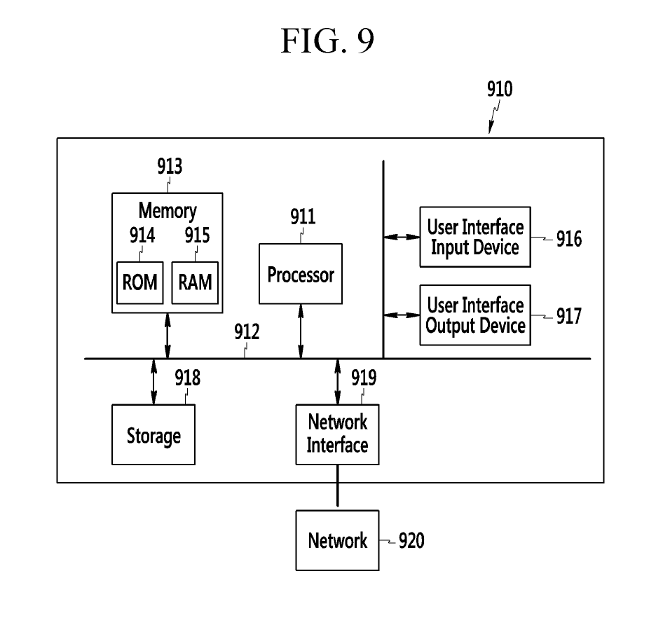

FIG. 9 is a schematic diagram illustrating a disaster information transmitting apparatus or a disaster information receiving apparatus according to another embodiment of the present invention.

As shown in FIG. 9, a computer system 910 may include one or more of a processor 911, a memory 913, a user input device 916, a user output device 917, and a storage 918, each of which communicates through a bus 912. The computer system 910 may also include a network interface 919 that is coupled to a network 920. The processor 911 may be a central processing unit (CPU) or a semiconductor device that executes processing instructions stored in the memory 913 and/or the storage 918. The memory 913 and the storage 918 may include various forms of volatile or non-volatile storage media. For example, the memory may include a read-only memory (ROM) 914 and a random access memory (RAM) 915.

The processor 911 may perform a function of the disaster information generator 110, the spreading unit 120, and the modulation unit 130 of the disaster information transmitting apparatus 100 or a function of the demodulation unit 220, the despreading unit 230, the disaster information analysis unit 240, and the controller 250 of the disaster information receiving apparatus 200.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

According to an exemplary embodiment of the present invention, by transmitting disaster information using a guard band of a terrestrial DTV broadcasting frequency band, disaster information can be transmitted without allocation of an additional frequency band while not having a large influence on receiving performance of a conventional digital broadcasting receiver. Further, by applying a despread error compensation unit, in a low SNR area, receiving performance of a receiving apparatus can be improved.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A disaster information transmitting apparatus, comprising:
a disaster information generator that generates disaster information;
a spreading unit that spreads the disaster information with a spreading code;
a modulation unit that modulates spread disaster information; and
a transmitting unit that transmits modulated disaster information using a guard existing between two adjacent broadcasting frequency channels.

2. The disaster information transmitting apparatus of claim 1, wherein the broadcasting frequency band is divided into a frequency block on a broadcasting channel basis,
the guard band is a frequency band that is not used between adjacent frequency blocks, and
a broadcasting signal is transmitted using a frequency block of a corresponding broadcasting channel.

3. A disaster information receiving apparatus, comprising:
a receiving unit that receives a signal comprising transmitted disaster information using a guard band existing between two adjacent broadcasting frequency channels from a disaster information transmitting apparatus;
a demodulation unit that demodulates a received signal;
a despreading unit that despreads a demodulated signal using a despreading code; and
a disaster information analysis unit that extracts the disaster information from a despread signal.

4. The disaster information receiving apparatus of claim 3, further comprising a controller that controls a television using the extracted disaster information.

5. The disaster information receiving apparatus of claim 4, wherein the controller comprises a set-top box.

6. The disaster information receiving apparatus of claim 3, wherein the despreading unit comprises:
a correlation unit that calculates a correlation value between a demodulated signal and the despreading code;
a frame synchronization detection unit that detects a data synchronization time point using a correlation value that is calculated by the correlation unit;
a despread error compensation unit that compensates and outputs a correlation value that is calculated by the correlation unit; and
a data determining unit that extracts a correlation value that is compensated by the despread error compensation unit to determine data at every cycle corresponding to a length of the despreading code based on the data synchronization time point.

7. The disaster information receiving apparatus of claim 6, wherein a compensation segment is set to the sum of lengths that are set at a previous time point and a following time point of a present time point of an input correlation value.

8. The disaster information receiving apparatus of claim 6, wherein the despreading unit further comprises a despread peak value extractor that extracts a correlation value of a corresponding location and that transfers the correlation value to the data determining unit at every cycle corresponding to a length of the despreading code based on the data synchronization time point among correlation values that are output from the despread error compensation unit.

9. The disaster information receiving apparatus of claim 6, wherein the despread error compensation unit outputs the sum of all correlation values of a compensation segment that is set based on a present correlation value as a compensation value of the present correlation value.

10. The disaster information receiving apparatus of claim 3, wherein the broadcasting frequency band is divided into a frequency block assigned to each broadcasting channel, and the guard band comprises a frequency band that is not used between adjacent frequency blocks.

11. A method of transmitting disaster information in a disaster information transmitting apparatus, the method comprising:
generating disaster information;
spreading the disaster information with a spreading code;
modulating the spread disaster information; and
transmitting the modulated disaster information using a guard band of a broadcasting frequency band.

12. The method of claim 11, wherein the broadcasting frequency band is divided into a frequency block assigned to each broadcasting channel, and the guard band is a frequency band that is not used between adjacent frequency blocks, and
the transmitting of the modulated disaster information comprises controlling signal intensity of the disaster information.

13. A method of receiving disaster information in a disaster information receiving apparatus, the method comprising:
receiving a signal comprising disaster information that is transmitted using a guard band of a broadcasting frequency band from the disaster information transmitting apparatus;
demodulating the received signal;
despreading the demodulated signal using a code which used for spreading; and
extracting the disaster information from the despread signal.

14. The method of claim 13, further comprising controlling a television using the extracted disaster information.

15. The method of claim 14, wherein the controlling of a television comprises turning on a power of the television.

16. The method of claim 14, wherein the controlling of a television comprises converting a broadcasting channel of the television to a disaster broadcasting channel.

17. The method of claim 13, wherein the despreading of the demodulated signal comprises:
calculating a correlation value between a demodulated signal and the code;
detecting a data synchronization time point using the calculated correlation value;
compensating and outputting the calculated correlation value; and
extracting a correlation value that is compensated at a corresponding location and determining data at every cycle corresponding to a length of the despreading code based on the data synchronization time point.

18. The method of claim 17, wherein the outputting of the calculated correlation value comprises calculating the sum of an entire correlation value of a compensation segment that is set based on a present correlation value as a compensation value of the present correlation value.

19. The method of claim 13, wherein the broadcasting frequency band is divided into a frequency block on a broadcasting channel basis, and
the guard band comprises a frequency band that is not used between adjacent frequency blocks.
